(19) United States
(12) Patent Application Publication
(10) Pub. No.: US 2007/0040463 A1
(43) Pub. Date: Feb. 22, 2007

(54) Drive for the adjustment of flaps

(76) Inventors: Andreas Zorweg, Liezen (AT); Peter Menzel, Anger (AT)

Correspondence Address: MARSHALL & MELHORN, FOUR SEAGATE, EIGHT FLOOR, TOLEDO, OH, 43604, US

(21) Appl. No.: 11/504,956

(22) Filed: Aug. 16, 2006

(30) Foreign Application Priority Data
Aug. 19, 2005 (DE) 10 2005 040 290.9

(51) Int. Cl. H02K 7/10; H02K 5/00

(52) U.S. Cl. 310/83; 310/89; 310/75 R; 74/606 R

(57) ABSTRACT

A drive is proposed for adjusting flaps, in particular flaps for supplying air in automotive vehicles, the drive having a drive motor received in a housing and a step-down gear. The housing comprises three housing parts, the second housing part having, on its one upper side, a receiving recess for insertion of the transmission parts from above and, on its other opposite lower side, a cavity for insertion of the drive motor from below. The transmission parts are fixed by a first housing part which is clipped to the second housing part and the drive motor is covered by a third housing part which is likewise clipped to the second housing part. The stator stack of the drive motor is advantageously received directly in the cavity and fixed to the second housing part, the rotor covering the stator stack in a bell-like manner

### RELATED APPLICATION

This application is claiming the benefit, under 35 USC §119, of German Patent Application No. DE 10 2005 040 290.9, filed on Aug. 19, 2005, which is hereby incorporated by reference in its entirety.

### FIELD OF THE INVENTION

The invention relates to a drive for the adjustment of flaps, in particular flaps for supplying air in automotive vehicles.

### BACKGROUND OF THE INVENTION

Actuators are known in the state of the art, in particular for heating, ventilation or air conditioning flaps in automotive vehicles. The actuators have a housing in which a drive motor and a step-down gear are disposed. The motor is connected to a motor worm which engages in a worm element disposed on an intermediate shaft. Another worm element is provided on the intermediate shaft and is connected to a driven gear. The actuation element of the flaps then engages in the driven gear.

### SUMMARY OF THE INVENTION

Starting from the state of the art described above, the object underlying the invention is to produce a drive for positioning flaps which can be mounted easily and has few movable parts. This object is achieved according to the invention by the characterizing features of the main claim in conjunction with the features of the preamble.

A drive is made available which is simple to mount and which has a small number of individual components as a result of the fact that an essentially flat intermediate housing or second housing part is provided which has, on its one upper side, receiving recesses for insertion of the transmission parts of the step-down gear and, on its other opposite lower side, a cavity for insertion of the drive motor from below, the second housing part having, on its one upper side, receiving recesses for insertion of the transmission parts from above and, on its other opposite lower side, a cavity for insertion of the drive motor from below, the transmission parts being fixed by the first housing part which can be connected to the second housing part, and the drive motor by a third housing part which can be connected to the second housing part.

It is advantageous that the stator stack of the motor is received directly in the cavity and is fixed on the second housing part and the rotor covers the stator stack in a bell-like manner, the cavity with the stator stack and the rotor being sealed by the third housing part. As a result, an extremely compact and space-saving construction is achieved.

The motor shaft of the rotor engages advantageously through the motor bearing onto the upper side of the second housing part so that the motor worm can be placed directly thereon.

It is particularly advantageous that the intermediate shaft which comprises worm parts, which are in engagement with the driven gear and the motor worm, is configured in one piece with the worm parts. It is furthermore advantageous that the intermediate shaft is situated with the one end in a receiving recess of the upper side of the second housing part the other end is clipped into a bearing provided on the upper side. The shaft thus rotates in the receiving recess and in the bearing without additional bearing parts being required.

It is furthermore advantageous that the drive motor is configured as a brushless direct current motor, which reduces noise.

It is particularly advantageous that a motor control unit is provided with a sensor, preferably a Hall sensor, on a printed circuit board which is mounted on the upper side of the second housing part in such a manner that the sensor engages in an opening which is provided between the lower and the upper side of the second housing part in the region of the cavity, the sensor being disposed at a slight spacing relative to the rotor which covers the stator in a bell-like manner.

It is particularly advantageous that the motor control unit provided on the printed circuit board has obstruction recognition in an integrated form which, as a function of the signals of the motor current and the motor voltage and the signal of the sensor, establishes whether the motor is running more slowly, is stationary or displays vibrations.

Finally, it is particularly advantageous that the first housing part and the third housing part have locking elements which can come into engagement with corresponding locking projections on the second housing part and hence seal the entire housing, the individual components being fixed.

### BRIEF DESCRIPTION OF THE DRAWINGS

Embodiments of the invention are represented in the drawings and are explained in more detail in the subsequent description. There are shown:

FIG. 1 is an exploded view of the drive according to the invention in perspective;

FIG. 2 is a perspective view of the second housing part from below without the motor;

FIG. 3 is a perspective view on the second housing part from below with the inserted stator stack;

FIG. 4 is a perspective view on the second housing part from below with the inserted stator stack and the bell-shaped rotor placed thereon; and

FIG. 5 is a perspective view on the second housing part with inserted step-down gear elements and printed circuit boards from the upper side.

### DETAILED DESCRIPTION OF THE PREFERRED EMBODIMENTS

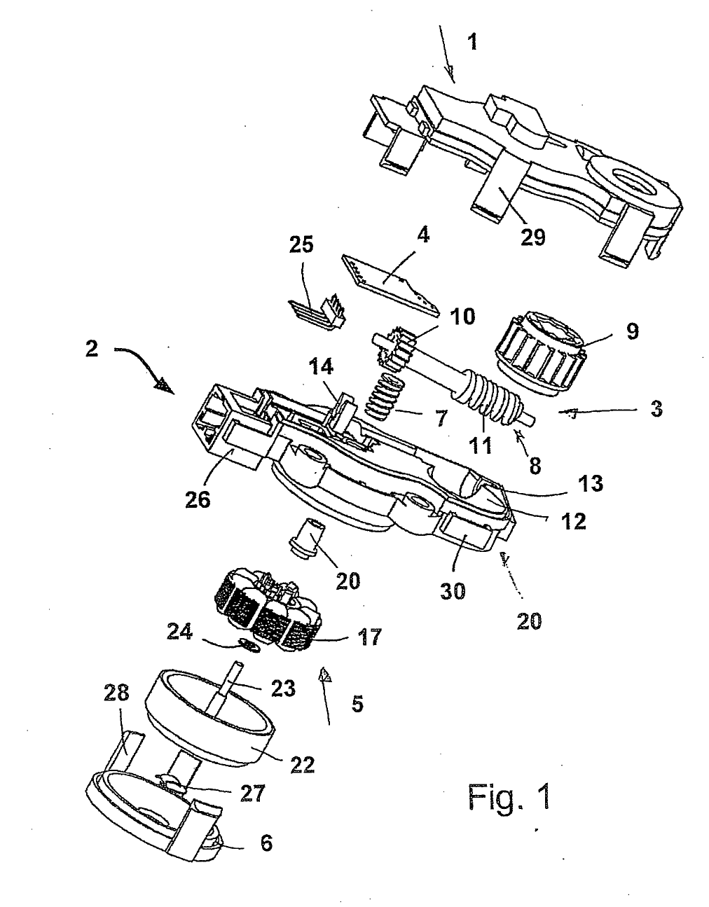

The actuator according to the invention for flaps in automotive vehicles is illustrated in detail in FIG. 1. It can be detected therefrom that the number of components is kept low.

The actuator has three housing parts, a first housing part 1 which fixes the transmission components of a step-down gear, a second housing part 2 which is also termed as an intermediate housing part and which receives the individual components of the step-down gear 3 and a fitted circuit board 4 from the one upper side, and from the other lower side, a drive motor 5, and a third lower housing part 6.

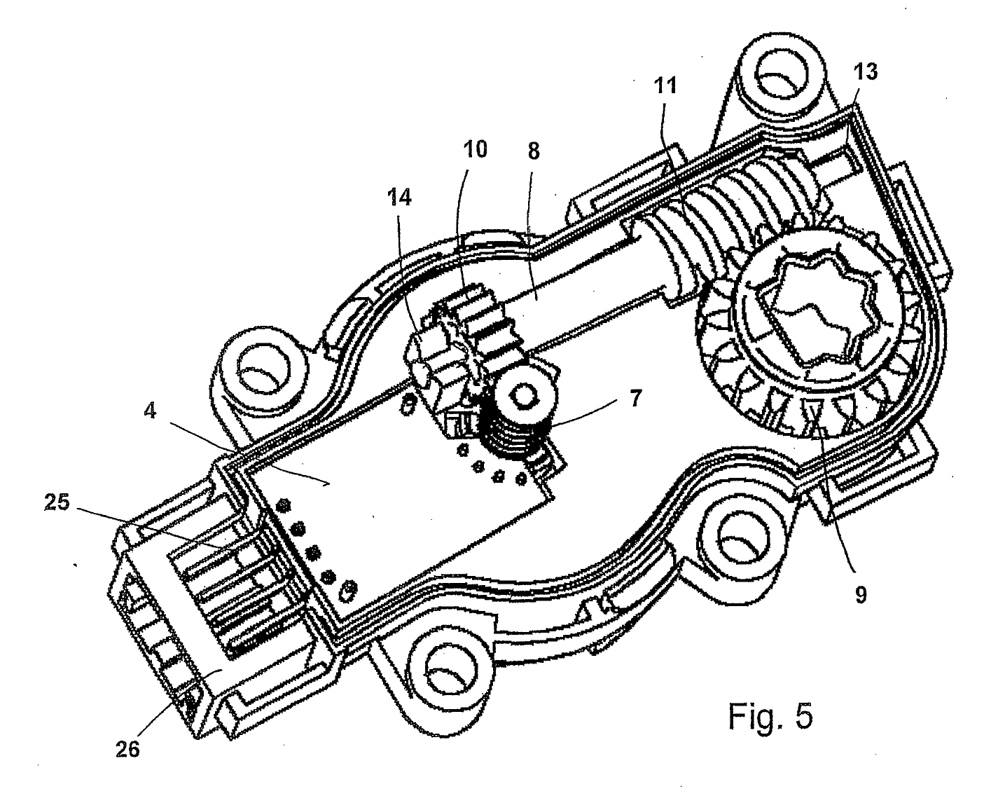

As can be detected from FIG. 1 and FIG. 5, which show the fitted second housing part from above, the step-down gear 3 comprises a motor worm 7 which is connected to the drive shaft of the motor 5, an intermediate shaft 8 and a driven gear 9. The intermediate shaft 8 is connected, in one piece, to a first worm element 10 which is in engagement with the motor worm 7, and a second worm element 11 which is in engagement with the driven gear 9. The driven gear 9 is connected to an actuation element of the corresponding flap, e.g. heating, ventilation and air conditioning flap. The components 7, 8, 9 are inserted from above (corresponding to FIG. 1) in receiving recesses 12 which are provided for this purpose and molded into the intermediate housing 2 on the upper side. The intermediate shaft 8 is thereby supported with its one end in a bearing recess 13 and with the other end in a bearing 14 with undercutting, the latter being configured as extensions which protrude from the surface of the intermediate housing 2 and in which the end of the intermediate shaft 8 is clipped. In this way, the intermediate shaft 8 is mounted obliquely, as a result of which straight toothing can be used for the driven gear 9.

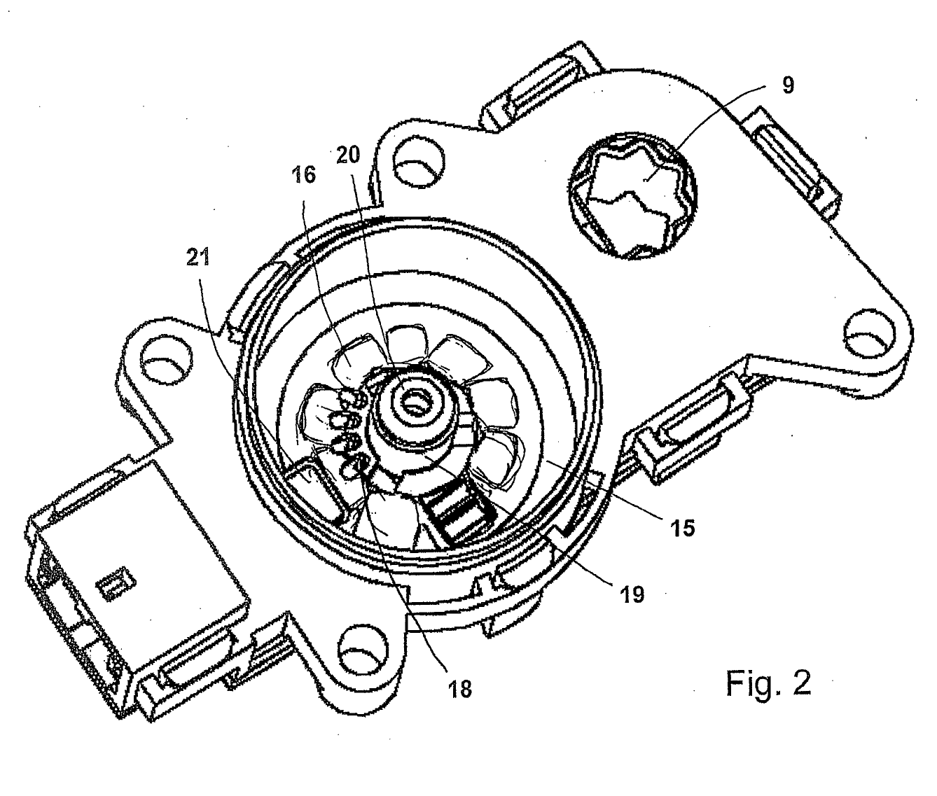

The intermediate housing 2 is shown in FIGS. 2 to 4 from the lower side, the different mounting steps intending to be illustrated in the various Figures. FIG. 2 shows the cavity 15 in which the motor 5 is to be inserted. The cavity has recesses 16 for the coils of the stator stack 17, contact pins 18 for the connections to the windings (U, V, W and star points), and a moulded-on central extension 19. A motor bearing 20 is pressed into the extension and serves to mount the motor shaft. Finally, an opening 21 is provided which allows a connection from the upper to the lower side of the intermediate housing 2.

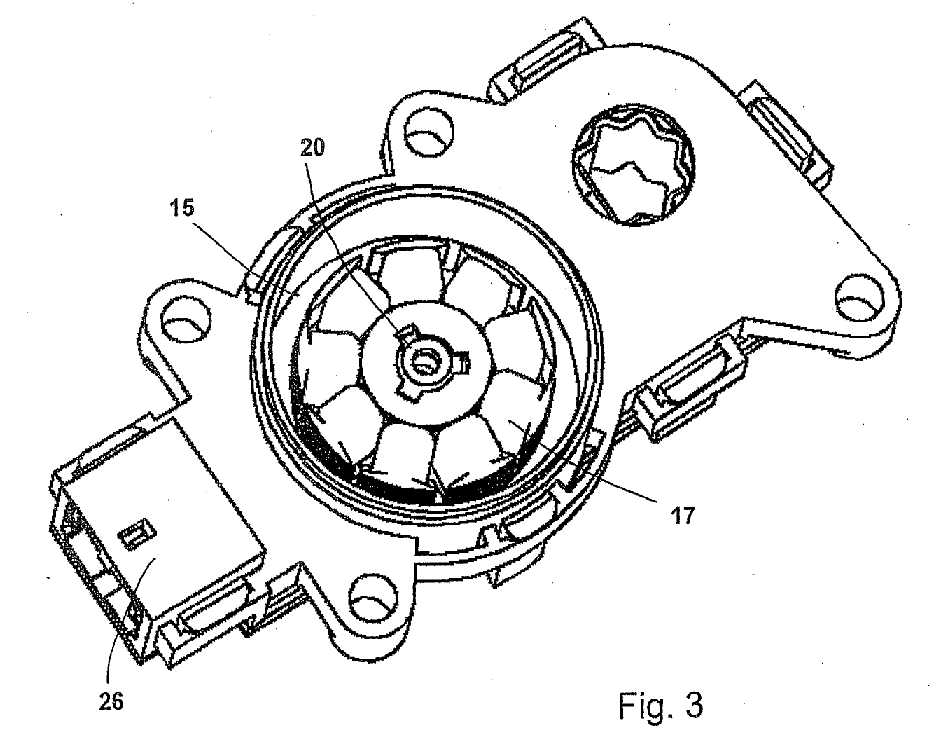

The stator stack 17, as shown in FIG. 3, is pressed onto the extension 19, the stator stack being able to be fixed axially by means of a clip and a locking disc. The pins 18, which are shown in FIG. 2 without the stator stack and serve there only for illustration, are inserted in the plastic material of the stator stack and protrude, after being pressed in, into the cavity 15 in the upper side of the third housing part of the intermediate housing 2.

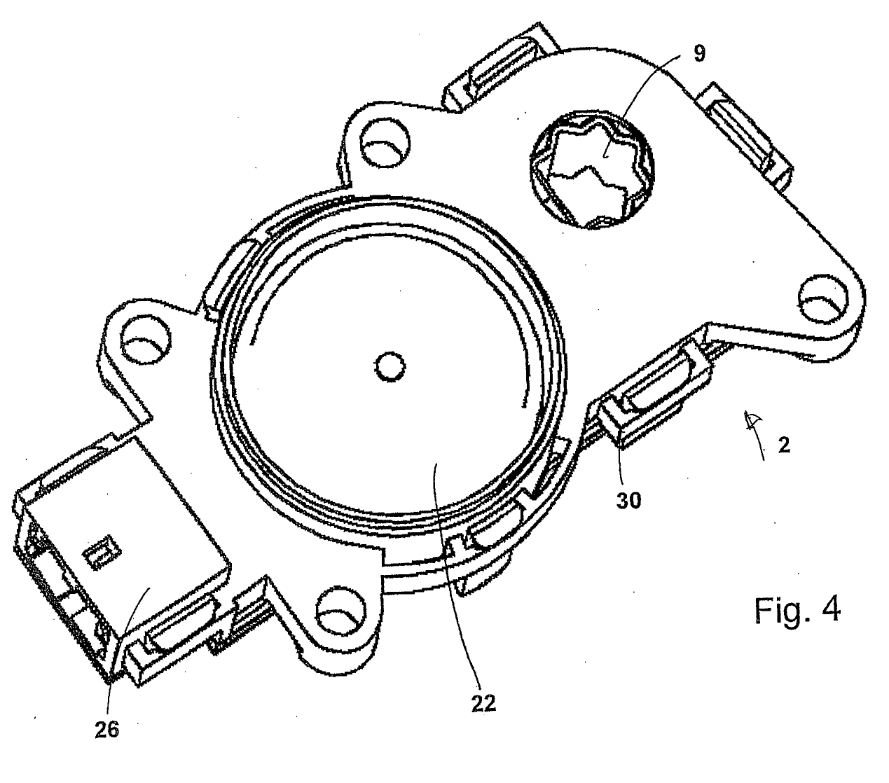

The rotor 22 of the motor 5 is configured as a rotor bell and is open towards the stator stack 17, the rotor shaft 23 being molded on centrally. The rotor is introduced corresponding to FIG. 4 with its shaft 23 into the rotor bearing 20, the shaft engaging through the stator stack centrally and the rotor bell 22 being disposed around the stator stack 17. Sliding discs 24 for the axial mounting are placed between motor bearing 2 and rotor bell. The motor worm 7 is connected securely to the motor shaft 23.

The motor 5 is actuated by a motor control unit, the motor control unit being configured preferably as an integrated circuit, e.g. as an ASIC (Application Specific Integrated Circuit). This circuit is mounted on the underside of the printed circuit board 4 with the corresponding strip conductors, the printed circuit board being positioned on the upper side of the intermediate housing 2 corresponding to FIG. 5 such that the integrated circuit engages in the opening 21. At least one sensor is assigned to the circuit, the sensor being configured in the embodiment as a Hall sensor and being disposed on the integrated circuit such that it is situated opposite the edge of the rotor bell 22 at a small spacing and therefore can detect the magnetic fields of the motor 17. In order to connect the strip conductors of the printed circuit board 4 externally, a contact pin set 25 is provided, the contact pin set being soldered or pressed onto the printed circuit board 4 and engaging in a plug housing 26 of the second housing part 2. The printed circuit board 4 is fixed with fixing elements, as can be detected from FIG. 5.

The motor 5 is covered by the third housing part 6, a spring 27 for the axial motor shaft support being disposed between the rotor bell 22 and the third housing part. The third housing part 6 is clipped via locking elements 28 to the second housing part 2. The first upper housing part 1 is likewise provided with locking elements 29 and locks into corresponding locking receiving means 30 on the intermediate housing 2, with fixing of the components of the step-down gear 3.

The motor 5 is configured preferably as a brushless direct current motor, the position of the rotor being able to be detected by means of the Hall sensor or even a plurality of Hall sensors and the speed of rotation being able to be determined by the motor control unit. As mentioned, the Hall sensor is integrated in the ASIC and, as described above, is disposed such that it can detect the magnetic field of the rotor. As a result, obstruction recognition is also possible by detecting a change in the speed of rotation and corresponding evaluation by the motor control unit. Of course other motors, e.g. a step motor, are also possible, however, the brushless direct current motor has the advantage that it has less vibration and noise than a step motor.

It can be readily appreciated that a motor control unit without a sensor can basically also be used with the present invention.

We claim:

1. A drive for adjusting flaps, in particular flaps for supplying air in automotive vehicles, having a housing, a drive unit received in the housing with a drive motor and a step-down gear, the housing having flat first and second housing parts (1, 2) which are connected to each other, comprising:
a plurality of receiving recesses (12, 13, 14) on an upper side of said second housing part (2) for insertion of a plurality of transmission parts (7, 8, 9) from above, said transmission parts being fixed by said first housing part (1); and
a cavity (15) on an opposite lower side of said second housing part (2) for insertion of said drive motor (5) from below;
wherein said drive motor (5) is fixed by a third housing part (6) which is connected to said second housing part (2).

2. The drive for adjusting flaps of claim 1, wherein a stator stack (17) of said motor (5) is received directly in said cavity (15) and fixed on said second housing (2) and a rotor (22) covers said stator stack (17) in a bell-like manner, said cavity (15) with said stator stack and said rotor being sealed by said third housing part (6).

3. The drive for adjusting flaps of claim 2, wherein a motor bearing (20) is pressed into an extension (19) provided in said cavity (15) of said second housing part (2) and said stator stack (17) is pressed onto said extension (19).

4. The drive for adjusting flaps of claim 3, wherein a motor shaft (23) of said rotor (22), via engagement through said motor bearing (20), protrudes towards said upper side of said second housing part (2).

5. The drive for adjusting flaps of claim 4, wherein a step-down gear (3) comprises a motor worm (7), an intermediate shaft (8) and a driven gear (9).

6. The drive for adjusting flaps of claim 5, wherein said intermediate shaft (8) comprises, in one piece, worm parts (10, 11) which are in engagement with said driven gear (9) and said motor worm.

7. The drive for adjusting flaps of claim 6, wherein said intermediate shaft (8) is situated with one end in a receiving recess (13) of said upper side of said second housing part (2) and, with the other end, is clipped into a bearing (14) provided on said upper-side with undercutting.

8. The drive for adjusting flaps of claim 7, wherein said drive motor (5) is configured as a brushless direct current motor.

9. The drive for adjusting flaps of claim 8, wherein a motor control unit is provided with at least one Hall sensor which is disposed on a printed circuit board (4) which is mounted on said upper side of said second housing part and is connected to contact elements (25) for connection to a plug arrangement.

10. The drive for adjusting flaps of claim 9, wherein an opening (21) to said upper side is provided in said second housing part (2) in the region of said cavity (15) which receives said motor and into which opening said sensor disposed on said printed circuit board (4) for detection of the magnetic field of said rotor (22) engages.

11. The drive for adjusting flaps of claim 10, wherein said motor control unit and said sensor are integrated ASIC components.

12. The drive for adjusting flaps of claim 11, wherein said motor control unit comprises obstruction recognition which, as a function of a sensor signal and the current and/or voltage values of said motor, detects an obstruction or a change in the speed of rotation and if necessary switches off said motor.

13. The drive for adjusting flaps of claim 12, wherein said housing part (1) and said third housing part (6) are clipped to said second housing part (2).
